(19) United States
(12) Patent Application Publication
(10) Pub. No.: US 2026/0125996 A1
(43) Pub. Date: May 7, 2026

(54) BLOW-BY GAS RECIRCULATION DEVICE

(71) Applicant: SUBARU CORPORATION, Tokyo (JP)

(72) Inventor: Hidenori ANZAI, Tokyo (JP)

(21) Appl. No.: 19/367,224

(22) Filed: Oct. 23, 2025

(30) Foreign Application Priority Data
Nov. 1, 2024 (JP) 2024-192584

(51) Int. Cl. F01M 13/00; F01M 13/02

(52) U.S. Cl. CPC F01M 13/0011; F01M 2013/0044; F01M 2013/027

(57) ABSTRACT

A blow-by gas recirculation device includes a first passage, a second passage, and a flow control valve unit. The first passage provides communication between a crank chamber of an internal combustion engine and a first region of an intake system downstream of a throttle valve, and recirculates blow-by gas to the intake system. The second passage provides communication between the crank chamber and a second region of the intake system upstream of the throttle valve. The flow control valve unit is disposed in the first passage to vary a passage area according to the first region pressure and the crank chamber pressure and includes a first valve that opens when the crank chamber pressure exceeds the first region pressure by a predetermined amount or more and a second valve that opens when the first region pressure exceeds the crank chamber pressure by a predetermined amount or more.

### CROSS-REFERENCE TO RELATED APPLICATIONS

The present application claims priority from Japanese Patent Application No. 2024-192584 filed on Nov. 1, 2024, the entire contents of which are hereby incorporated by reference.

### BACKGROUND

The disclosure relates to a blow-by gas recirculation device.

Conventionally, there has been known a technique in which blow-by gas leaking from a combustion chamber of an internal combustion engine into a crankcase is recirculated to an intake system of the internal combustion engine and used again as intake air. For example, Japanese Unexamined Patent Application Publication (JP-A) No. 2014-163347 discloses a configuration of an internal combustion engine including a first passage that provides communication between an inner chamber in which blow-by gas accumulates and a downstream side of a throttle valve in an intake passage, a second passage that provides communication between the inner chamber and an upstream side of a supercharger in the intake passage, and a PCV valve disposed to open and close the first passage.

### SUMMARY

An aspect of the disclosure provides a blow-by gas recirculation device including a first passage, a second passage, and a flow control valve unit. The first passage is configured to provide communication between a crank chamber of an internal combustion engine and a first region of an intake system, the first region being located downstream of a throttle valve of the intake system, and configured to recirculate blow-by gas to the intake system. The second passage is configured to provide communication between the crank chamber and a second region of the intake system, the second region being located upstream of the throttle valve. The flow control valve unit is disposed in the first passage and configured to vary a passage area according to a pressure in the first region and a pressure in the crank chamber. The flow control valve unit includes a first valve configured to open when the pressure in the crank chamber exceeds the pressure in the first region by a predetermined amount or more and a second valve configured to open when the pressure in the first region exceeds the pressure in the crank chamber by a predetermined amount or more.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating a configuration example of an internal combustion engine including a blow-by gas recirculation device according to an embodiment of the disclosure.

FIG. 2 is a schematic diagram illustrating a configuration example of a flow control valve unit of the blow-by gas recirculation device according to the embodiment of the disclosure.

FIG. 3 is an explanatory diagram illustrating an operation of the flow control valve unit during a low-load operation of the internal combustion engine.

FIG. 4 is an explanatory diagram illustrating a flow of blow-by gas during low-load operation of the internal combustion engine.

FIG. 5 is an explanatory diagram illustrating an operation of the flow control valve unit during a medium-load operation of the internal combustion engine.

FIG. 6 is an explanatory diagram illustrating a flow of the blow-by gas during medium-load operation of the internal combustion engine.

FIG. 7 is an explanatory diagram illustrating an operation of the flow control valve unit during full boost of the internal combustion engine.

FIG. 8 is an explanatory diagram illustrating a flow of the blow-by gas during full boost of the internal combustion engine.

FIG. 9 is a schematic view illustrating a modification of the flow control valve unit of the blow-by gas recirculation device according to the embodiment of the disclosure.

### DETAILED DESCRIPTION

The PCV valve disclosed in JP-A No. 2014-163347 has a configuration of a mechanical (differential-pressure-operated) flow control valve in which a valve body, which is pressed against a valve seat by an elastic urging force, is displaced in a direction away from the valve seat against the elastic urging force by pressure of the blow-by gas, thereby increasing or decreasing a flow rate of the blow-by gas flowing through the first passage.

When a mechanical flow control valve is used, during a low-load operation of the internal combustion engine in which supercharging is not substantially performed, the pressure downstream of the throttle valve becomes a negative pressure, and the flow control valve opens, so that fresh air can be introduced into the inner chamber (crank chamber) via the second passage. Therefore, the blow-by gas can be discharged together with the fresh air via the first passage, and fuel, moisture, and the like contained in the blow-by gas can be scavenged.

However, when supercharging of the internal combustion engine starts, the pressure downstream of the throttle valve becomes a positive pressure, and the flow control valve is closed. In this case, although the blow-by gas can be discharged via the second passage, fresh air cannot be introduced into the crank chamber. Therefore, depending on the fuel concentration and moisture in the blow-by gas and the temperature in the crank chamber or the wall surface temperature, there is a possibility that fuel or moisture will accumulate in the crank chamber.

It is desirable to provide a blow-by gas recirculation device capable of recirculating blow-by gas to an intake system while introducing fresh air into a crank chamber even after supercharging of an internal combustion engine has started.

Hereinafter, a preferred embodiment of the disclosure will be described in detail with reference to the accompanying drawings. Specific dimensions, materials, numerical values, and the like illustrated in the embodiment described below are merely examples for facilitating understanding of the disclosure, and unless otherwise specified, the disclosure is not limited thereto. Note that, in the present specification and the drawings, components having substantially the same configuration are denoted by the same reference signs, and redundant description thereof will be omitted. Internal Combustion Engine System Provided with Blow-by Gas Recirculation Device

First, a configuration example of an internal combustion engine system including a blow-by gas recirculation device according to the present embodiment will be described.

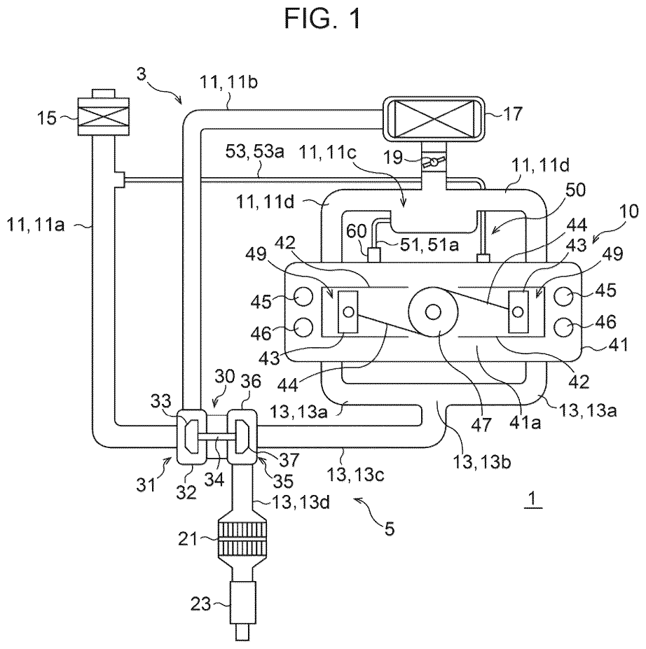

FIG. 1 is a schematic diagram illustrating a schematic configuration of an internal combustion engine system. An internal combustion engine system 1 includes an internal combustion engine 10, an intake system 3, an exhaust system 5, and a blow-by gas recirculation device 50. The internal combustion engine 10 illustrated in FIG. 1 is a horizontally-opposed internal combustion engine in which multiple cylinders 42 are disposed to face each other. However, the internal combustion engine 10 is not limited to the horizontally-opposed internal combustion engine 10, and may be an in-line, V, or another configuration of internal combustion engine.

The internal combustion engine 10 includes multiple cylinders 42 formed in a crankcase 41. Pistons 43 are disposed inside the cylinders 42 such that each of the pistons 43 is movable back and forth inside the corresponding cylinder 42. Combustion chambers 49 are each defined by an inner peripheral surface of a respective one of the cylinders 42 and a crown surface of the corresponding piston 43. Connecting rods 44 are each coupled at its one end to a respective one of the pistons 43. The other ends of the connecting rods 44 are coupled to a crankshaft 47 that is disposed in a crank chamber 41a provided in the crankcase 41. The crankshaft 47 is rotatably supported by a bearing (not illustrated) in the crankcase 41. As the pistons 43 move back and forth inside the cylinders 42, the crankshaft 47 coupled via the connecting rods 44 rotates.

Each of the cylinders 42 has an intake port 45 and an exhaust port 46. The intake ports 45 and the exhaust ports 46 are each in communication with a respective one of the combustion chambers 49. Each of the combustion chambers 49 communicates with an intake passage via its corresponding intake port 45, and communicates with an exhaust passage via its corresponding exhaust port 46. Each of the intake ports 45 is opened and closed by an intake valve (not illustrated). Each of the exhaust ports 46 is opened and closed by an exhaust valve (not illustrated). The intake valves and the exhaust valves are driven in synchronization with the rotation of the crankshaft 47, thereby allowing intake into the combustion chambers 49 and exhaust from the combustion chambers 49.

Each of the combustion chambers 49 is provided with a fuel injection valve and a spark plug (both not illustrated). In each of the combustion chambers 49, fuel injected from the fuel injection valve into the combustion chamber 49 is mixed with intake air introduced into the combustion chamber 49 via the corresponding intake port 45 to form an air-fuel mixture. The air-fuel mixture is ignited by the spark plug at a predetermined timing, and the air-fuel mixture is combusted in the combustion chamber 49. As a result, the pistons 43 move back and forth inside the cylinders 42, and the reciprocating motions of the pistons 43 are converted into the rotational motion of the crankshaft 47 via the connecting rods 44.

The intake system 3 includes an intake pipe 11, an air cleaner 15, a compressor 31 of a supercharger 30, an intercooler 17, and a throttle valve 19. The intake pipe 11 has an intake passage. The intake passage includes a first intake passage 11a located on the upstream side of the compressor 31, a second intake passage 11b coupling the compressor 31 to the intercooler 17, an intake manifold 11c disposed on the downstream side of the throttle valve 19, and a third intake passage 11d coupling the intake manifold 11c to each of the intake ports 45. Intake air that has been purified by the air cleaner 15 is introduced into the combustion chambers 49 through the intake passages 11a to 11d.

The exhaust system 5 includes an exhaust pipe 13, a turbine 35 of the supercharger 30, a catalyst 21, and a muffler (silencer) 23. The exhaust pipe 13 has an exhaust passage. The exhaust passage includes a first exhaust passage 13a coupled to each of the exhaust ports 46, an exhaust manifold 13b, a second exhaust passage 13c coupling the exhaust manifold 13b to the turbine 35, and a third exhaust passage 13d located on the downstream side of the turbine 35. Exhaust gas that is discharged from each of the combustion chambers 49 passes through the exhaust passage, is purified by the catalyst 21, and is discharged via the muffler 23.

The supercharger 30 includes the compressor 31, the turbine 35, and a turbine shaft 34. The compressor 31 includes a compressor housing 32 whose internal space also serves as part of an intake flow path, and a compressor impeller 33 accommodated in the compressor housing 32. The compressor impeller 33 is coupled to a turbine impeller 37 via the turbine shaft 34 and rotates integrally with the turbine impeller 37. The compressor impeller 33 is rotated by the rotational power of the turbine impeller 37 so as to compress intake air.

The turbine 35 includes a turbine housing 36 whose internal space also serves as part of an exhaust flow path, and the turbine impeller 37 accommodated in the turbine housing 36. The turbine impeller 37 rotates under the flow of exhaust gas discharged from each of the combustion chambers 49.

The blow-by gas recirculation device 50 recirculates, to the intake system 3, blow-by gas that has leaked from the combustion chambers 49 into the crank chamber 41a through spaces between the cylinders 42 and the pistons 43.

Next, the configuration of the blow-by gas recirculation device 50 will be described in detail.

The blow-by gas recirculation device 50 includes a first coupling pipe 51, a second coupling pipe 53, and a flow control valve unit 60. The first coupling pipe 51 couples the crank chamber 41a to a first region of the intake system 3 that is located downstream of the throttle valve 19. The first coupling pipe 51 has a first passage 51a. The second coupling pipe 53 couples the crank chamber 41a to a second region of the intake system 3 that is located upstream of the throttle valve 19. The second coupling pipe 53 has a second passage 53a.

In the present embodiment, the first coupling pipe 51 is coupled to the first region through which the intake air pressurized by the supercharger 30 passes, and the second coupling pipe 53 is coupled to the second region through which the intake air before being pressurized by the supercharger 30 passes. In the case illustrated in FIG. 1, the first passage 51a provides communication between the crank chamber 41a and the intake manifold (first region) 11c. The second passage 53a provides communication between the crank chamber 41a and the first intake passage (second region) 11a located upstream of the compressor 31.

The first passage 51a provides communication between the crank chamber 41a and the intake manifold 11c via an oil separator (not illustrated). The second passage 53a provides communication between the crank chamber 41a and the first intake passage 11a via the oil separator (not illustrated). The oil separator is disposed in communication with the interior of the crank chamber 41a and separates, from the blow-by gas that has leaked into the crank chamber 41a through spaces between the cylinders 42 and the pistons 43, oil mixed in the blow-by gas.

The flow control valve unit 60 is disposed in the first passage 51a and varies a passage area according to a pressure inside the intake manifold 11c and a pressure inside the crank chamber 41a. The flow control valve unit 60 may be provided integrally with, for example, an oil separator provided at the crankcase 41. The flow control valve unit 60 includes a first valve and a second valve. The first valve opens when the pressure inside the crank chamber 41a exceeds the pressure inside the intake manifold 11c by a predetermined amount or more, and the second valve opens when the pressure inside the intake manifold 11c exceeds the pressure inside the crank chamber 41a by a predetermined amount or more.

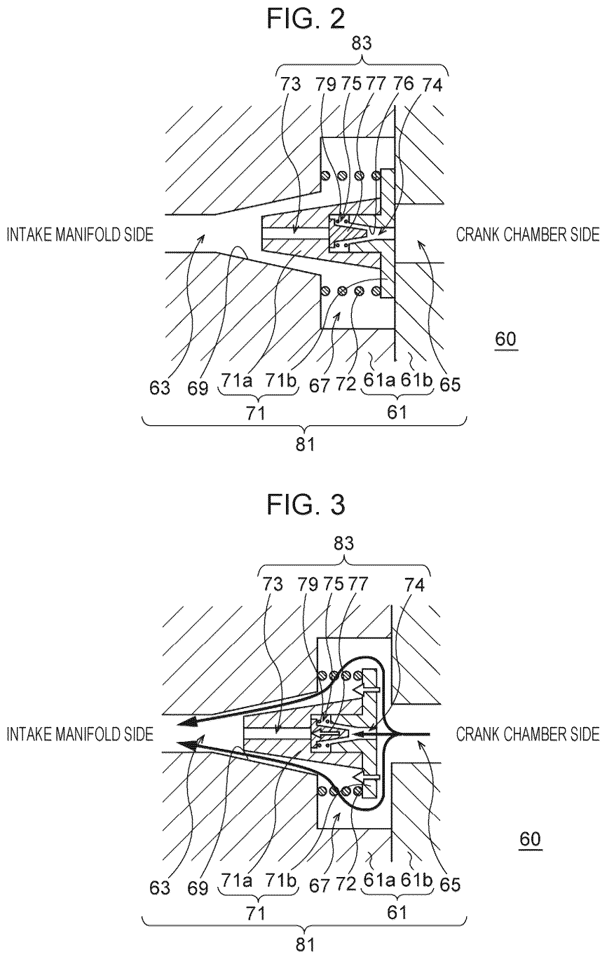

FIG. 2 is a schematic view illustrating an example of the configuration of the flow control valve unit 60.

The flow control valve unit 60 includes a first valve 81 and a second valve 83 in a housing 61. The flow control valve unit 60 of the blow-by gas recirculation device 50 according to the present embodiment has a configuration in which a first piston 71 that is a valve body of the first valve 81 includes the second valve 83.

The first valve 81 includes the housing 61, the first piston 71, and a first coil spring 72. The housing 61 includes a first housing 61a and a second housing 61b joined to each other. The second housing 61b may be a portion of the crankcase 41.

The housing 61 has a first hole 63 communicating with the intake manifold 11c, a second hole 65 communicating with the crank chamber 41a, and a first piston holding space 67 positioned between the first hole 63 and the second hole 65. A portion of the first hole 63 that is coupled to the first piston holding space 67 has a tapered shape whose diameter increases toward the first piston holding space 67. A portion of an inner peripheral surface of this tapered shape serves as a seat surface 69 on which the first piston 71 seats.

The first piston 71 is provided in the first piston holding space 67. The first piston 71 includes a first component 71a on the intake manifold 11c side and a second component 71b on the crank chamber 41a side, which are joined together. A portion of the first component 71a is located in the first hole 63. The first component 71a is tapered toward the intake manifold 11c and has an outer peripheral surface that is in contact with the seat surface 69. A portion of a surface of the second component 71b that faces the crank chamber 41a is in contact with the periphery of an opening of the second hole 65 of the housing 61. A portion of the surface of the second component 71b that faces the intake manifold 11c supports the first coil spring 72.

In the first piston holding space 67, the first coil spring 72 is supported in a compressed state between a surface of the first housing 61a facing the crank chamber 41a and a surface of the second component 71b facing the intake manifold 11c. The first piston 71 is constantly urged toward the crank chamber 41a by the first coil spring 72. Therefore, when the pressure in the intake manifold 11c and the pressure in the crank chamber 41a are equal to each other, the first piston 71 is pressed against the second housing 61b by an urging force of the first coil spring 72.

On the other hand, when an urging force that pushes the first piston 71 toward the first housing 61a by the pressure in the crank chamber 41a exceeds the sum of an urging force that pushes the first piston 71 toward the second housing 61b by the pressure in the intake manifold 11c and the urging force of the first coil spring 72, the first piston 71 moves toward the first housing 61a. The position of the first piston 71 is determined by the pressure in the crank chamber 41a and the pressure in the intake manifold 11c. When the difference obtained by subtracting the pressure in the intake manifold 11c from the pressure in the crank chamber 41a exceeds a predetermined threshold value, the first piston 71 seats on the seat surface 69 of the first housing 61a.

The second valve 83 includes the first piston 71, a second piston 77, and a second coil spring 79. The first piston 71 has a first internal hole 73 communicating with the intake manifold 11c, a second internal hole 74 communicating with the crank chamber 41a, and a second piston holding space 75 positioned between the first internal hole 73 and the second internal hole 74. A portion of the second internal hole 74 that is coupled to the second piston holding space 75 has a tapered shape whose diameter increases toward the second piston holding space 75. A portion of an inner peripheral surface of this tapered shape serves as a seat surface 76 on which the second piston 77 seats.

The second piston 77 is provided in the second piston holding space 75. A portion of the second piston 77 is located in the second internal hole 74. A portion of the second piston 77 is tapered toward the crank chamber 41a and has an outer peripheral surface that is in contact with the seat surface 76. A portion of a surface of the second piston 77 that faces the intake manifold 11c is in contact with the periphery of an opening of the first internal hole 73 of the first piston 71. A portion of the surface of the second piston 77 that faces the crank chamber 41a supports the second coil spring 79.

In the second piston holding space 75, the second coil spring 79 is supported in a compressed state between a surface of the second component 71b of the first piston 71 facing the intake manifold 11c and a surface of the second piston 77 facing the crank chamber 41a. The second piston 77 is constantly urged toward the first component 71a of the first piston 71 by the second coil spring 79. Therefore, when the pressure in the intake manifold 11c and the pressure in the crank chamber 41a are the same, the second piston 77 is pressed against the first component 71a of the first piston 71 by an urging force of the second coil spring 79.

On the other hand, when an urging force that pushes the second piston 77 toward the second component 71b of the first piston 71 by the pressure in the intake manifold 11c exceeds the sum of an urging force that pushes the second piston 77 toward the first component 71a of the first piston 71 by the pressure in the crank chamber 41a and the urging force of the second coil spring 79, the second piston 77 moves toward the second component 71b. The position of the second piston 77 is determined by the pressure in the crank chamber 41a and the pressure in the intake manifold 11c. When the difference obtained by subtracting the pressure in the crank chamber 41a from the pressure in the intake manifold 11c exceeds a predetermined threshold value, the second piston 77 seats on the seat surface 76 of the second component 71b of the first piston 71, and the second valve 83 closes.

The flow control valve unit 60 configured as described above has a configuration in which the first valve 81 opens when the pressure in the crank chamber 41a exceeds the pressure in the intake manifold 11c by a predetermined amount or more, and in which the second valve 83 opens when the pressure in the intake manifold 11c exceeds the pressure in the crank chamber 41a by a predetermined amount or more.

### Operation

Next, an operation of the blow-by gas recirculation device 50 according to the present embodiment will be described.

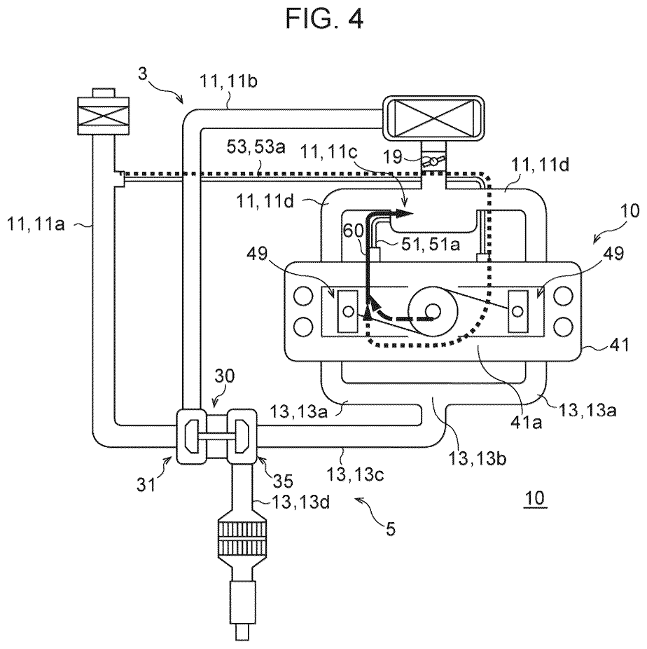

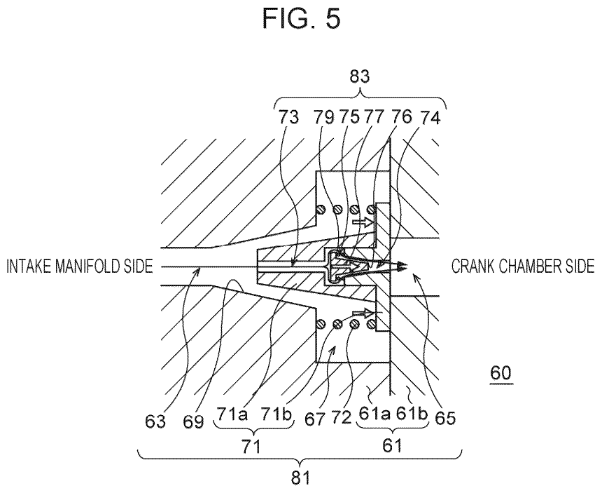

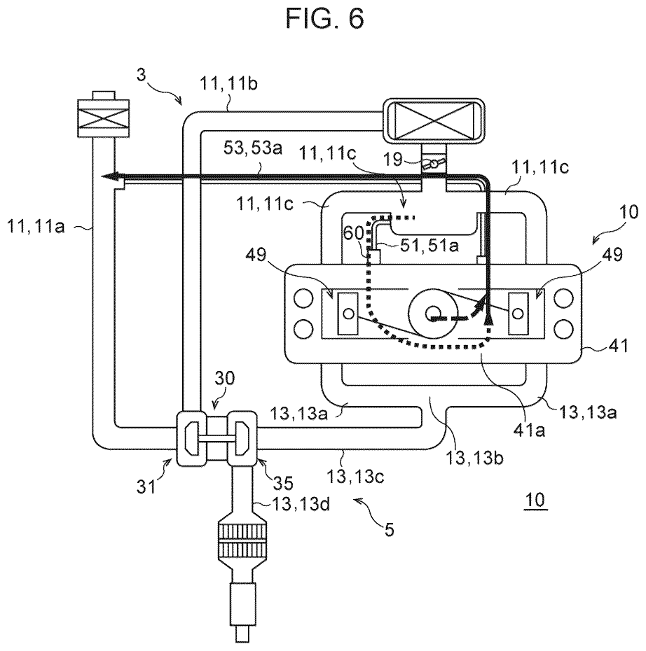

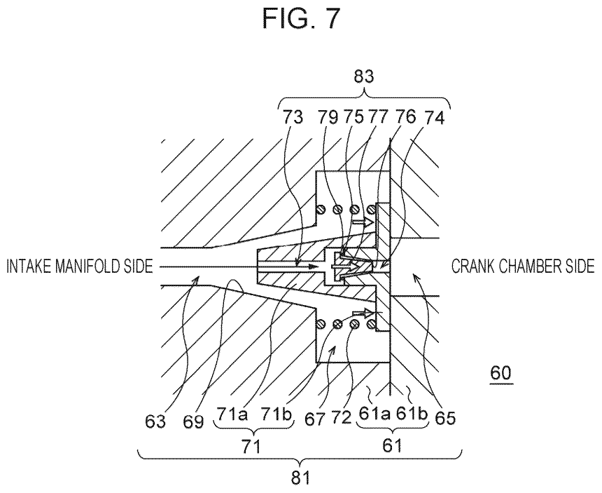

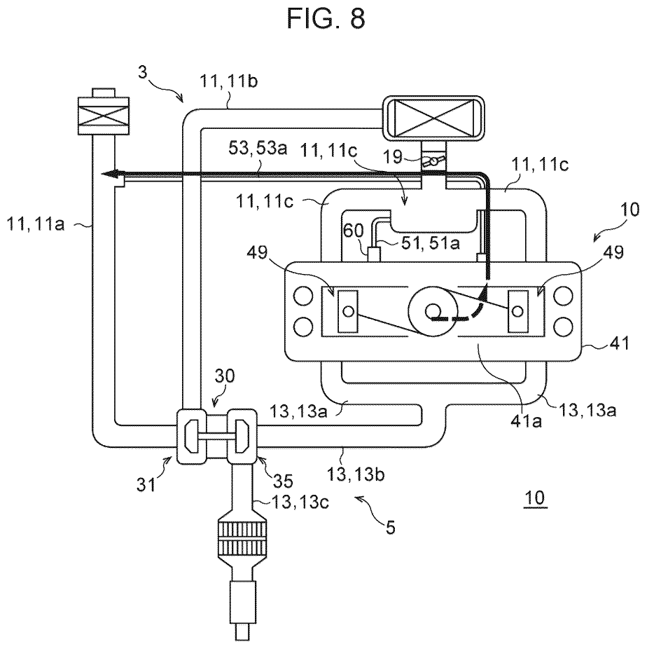

FIGS. 3 to 8 are diagrams for explaining the operation of the blow-by gas recirculation device 50. FIG. 3 illustrates an operating state of the flow control valve unit 60 in a state where the internal combustion engine 10 is operating at low load, and FIG. 4 illustrates a flow of the blow-by gas in a state where the internal combustion engine 10 is operating at low load. FIG. 5 illustrates the operating state of the flow control valve unit 60 during supercharging of the internal combustion engine 10, and FIG. 6 illustrates the flow of the blow-by gas during supercharging of the internal combustion engine 10. FIG. 7 illustrates the operating state of the flow control valve unit 60 during full boost of the internal combustion engine 10, and FIG. 8 illustrates the flow of the blow-by gas during full boost of the internal combustion engine 10.

In a low-load operating state in which the supercharger 30 is not substantially supercharging, the degree of opening of the throttle valve 19 is small, and the pressure in the intake manifold 11c is negative. Therefore, the second piston 77 is pressed against the first component 71a of the first piston 71 by the negative pressure in the intake manifold 11c, the pressure in the crank chamber 41a, and the urging force of the second coil spring 79, and the second valve 83 is closed. In addition, together with the pressure in the crank chamber 41a, the negative pressure in the intake manifold 11c generates a force to cause the first piston 71 to move toward the first housing 61a, and as illustrated in FIG. 3, the first piston 71 moves toward the first housing 61a against the urging force of the first coil spring 72, thereby opening the first valve 81. In this case, as the load of the internal combustion engine 10 approaches a medium load state, the negative pressure on the intake manifold 11c side becomes smaller, and the amount of movement of the first piston 71 becomes smaller, so that a passage area defined by the first valve 81 in an open state increases.

During low-load operation of the internal combustion engine 10, the negative pressure in the intake manifold 11c is relatively small, and the difference between the pressure in the intake manifold 11c and the pressure in the crank chamber 41a is small, so that the first piston 71 does not seat on the seat surface 69 of the housing 61. Therefore, a flow path is provided through which the blow-by gas is discharged from the crank chamber 41a side to the intake manifold 11c side.

In this case, as illustrated in FIG. 4, intake air (dotted line) is introduced into the crank chamber 41a via the second passage 53a by the negative pressure in the intake manifold 11c, and the blow-by gas (broken line) in the crank chamber 41a is recirculated to the intake manifold 11c together with fresh air (intake air) via the first passage 51a (solid line). As a result, during low-load operation of the internal combustion engine 10, the blow-by gas is scavenged from the crank chamber 41a, and mixing of fuel and moisture into the interior of the crank chamber 41a or into lubricating oil can be suppressed.

In a medium-load operating state in which the internal combustion engine 10 is supercharged by the supercharger 30, the pressure in the intake manifold 11c is positive. Therefore, the force that pushes the first piston 71 toward the first housing 61a by the pressure in the crank chamber 41a is smaller than the force that pushes the first piston 71 toward the second housing 61b by the pressure in the intake manifold 11c and the urging force of the first coil spring 72. Therefore, as illustrated in FIG. 5, the first piston 71 is pressed against the second housing 61b.

In this case, the force that pushes the second piston 77 toward the second component 71b of the first piston 71 by the pressure in the intake manifold 11c exceeds the force that pushes the second piston 77 toward the first component 71a of the first piston 71 by the pressure in the crank chamber 41a and the urging force of the second coil spring 79. Accordingly, as illustrated in FIG. 5, the second piston 77 moves toward the second component 71b of the first piston 71 against the urging force of the second coil spring 79, thereby opening the second valve 83. In this case, the pressure in the intake manifold 11c increases as the load of the internal combustion engine 10 increases, and the amount of movement of the second piston 77 increases, so that a passage area defined by the second valve 83 in an open state increases.

In this case, as illustrated in FIG. 6, the intake air (dotted line) is introduced into the crank chamber 41a from the intake manifold 11c via the first passage 51a, and the blow-by gas (broken line) in the crank chamber 41a is recirculated to the first intake passage 11a together with the fresh air (intake air) via the second passage 53a (solid line). As a result, during medium-load operation of the internal combustion engine 10, the blow-by gas is scavenged from the crank chamber 41a, and mixing of fuel and moisture into the interior of the crank chamber 41a or into lubricating oil can be suppressed.

Further, in a high-load operating state in which the internal combustion engine 10 is fully boosted by the supercharger 30, the pressure in the intake manifold 11c further increases. Therefore, as illustrated in FIG. 7, the second piston 77 is pressed against the seat surface 76 of the second component 71b of the first piston 71 while the first valve 81 remains closed, and the second valve 83 is also closed.

In this case, as illustrated in FIG. 8, the blow-by gas (broken line) in the crank chamber 41a is recirculated to the first intake passage 11a via the second passage 53a (solid line). As a result, during high-load operation of the internal combustion engine 10, the blow-by gas is scavenged from the crank chamber 41a, and mixing of fuel and moisture into the interior of the crank chamber 41a or into lubricating oil can be suppressed. In this case, the first and second valves 81 and 83 of the flow control valve unit 60 are both closed, and intake air is not introduced from the intake manifold 11c into the crank chamber 41a via the first passage 51a. Therefore, supercharging leakage is eliminated, and an output in a fully open state of the throttle valve 19 during high-load operation can be secured.

### Effects

As described above, the blow-by gas recirculation device 50 according to the present embodiment includes the first passage 51a, the second passage 53a, and the flow control valve unit 60. The first passage 51a provides communication between the crank chamber 41a of the internal combustion engine 10 and the intake manifold 11c of the intake system 3, which is located downstream of the throttle valve 19 of the intake system 3, and recirculates the blow-by gas to the intake system 3. The second passage 53a provides communication between the crank chamber 41a and the first intake passage 11a of the intake system 3, which is located upstream of the throttle valve 19 of the intake system 3. The flow control valve unit 60 is disposed in the first passage 51a and varies the passage area according to the pressure in the intake manifold 11c and the pressure in the crank chamber 41a. The flow control valve unit 60 includes the first valve 81 that opens when the pressure in the crank chamber 41a exceeds the pressure in the intake manifold 11c by a predetermined amount or more, and the second valve 83 that opens when the pressure in the intake manifold 11c exceeds the pressure in the crank chamber 41a by a predetermined amount or more.

Therefore, even after supercharging of the internal combustion engine 10 has started, fresh air can be introduced into the crank chamber 41a, and the blow-by gas that has leaked from the combustion chamber 49 into the crank chamber 41a can be scavenged with the fresh air and recirculated to the intake system 3.

Further, the blow-by gas recirculation device 50 according to the present embodiment includes the second valve 83 in the first piston 71 of the first valve 81 of the flow control valve unit 60. Therefore, the flow control valve unit 60 can be designed to be compact, and its installability to the internal combustion engine 10 can be enhanced.

Further, the blow-by gas recirculation device 50 according to the present embodiment has the internal holes 73 and 74 in the first piston 71 of the first valve 81, and the second valve 83 varies the opening areas of the internal holes 73 and 74. Therefore, when there is a mechanical flow control valve used in the related art, the flow control valve unit 60 can be constructed by incorporating the second valve 83 into a valve body of the flow control valve, and the flow control valve unit 60 can be provided without changing the layout of the internal combustion engine 10.

Further, in the blow-by gas recirculation device 50 according to the present embodiment, the second valve 83 closes when a difference obtained by subtracting the pressure in the crank chamber 41a from the pressure in the intake manifold 11c exceeds a predetermined threshold value. Therefore, supercharging leakage is eliminated when the throttle valve 19 is fully opened during, for example, full boost, and the output in the fully opened state of the throttle valve 19 can be secured.

### Modifications

Although the blow-by gas recirculation device according to the present embodiment has been described above, the flow control valve unit described in the above embodiment can be modified in various ways. Some modifications of the flow control valve unit will be described below.

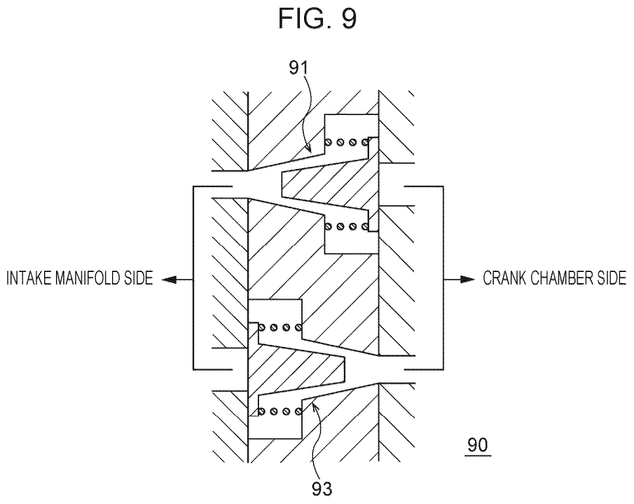

In the flow control valve unit 60 described above, although the second valve 83 is disposed in the first piston 71, which is the valve body of the first valve 81, the first valve 81 and the second valve 83 may be disposed independently. FIG. 9 illustrates a modification of the flow control valve unit in which the first valve and the second valve are disposed independently. A flow control valve unit 90 according to the modification includes a first valve 91 that opens when the pressure in the crank chamber 41a exceeds the pressure in the intake manifold 11c by a predetermined amount or more, and a second valve 93 that opens when the pressure in the intake manifold 11c exceeds the pressure in the crank chamber 41a by a predetermined amount or more.

The first valve 91 and the second valve 93 are disposed so as to communicate with the intake manifold 11c and the crank chamber 41a, respectively. Even with the flow control valve unit 90 in which the first valve 91 and the second valve 93 are disposed independently as described above, effects similar to those of the blow-by gas recirculation device 50 according to the above-described embodiment can be obtained.

Further, in the flow control valve unit 60 described above, although the second valve 83 is disposed in the first piston 71, which is the valve body of the first valve 81, the configuration of the flow control valve unit 60 illustrated in FIG. 2 may be laterally reversed such that the first valve, which opens when the pressure in the crank chamber exceeds the pressure in the intake manifold by a predetermined amount or more, is disposed in the second piston of the second valve, which opens when the pressure in the intake manifold exceeds the pressure in the crank chamber by a predetermined amount or more. Even with the flow control valve unit 60 having such a configuration, effects similar to those of the blow-by gas recirculation device 50 according to the above-described embodiment can be obtained.

Although the embodiment of the disclosure has been described in detail above with reference to the accompanying drawings, the disclosure is not limited to such a case. It is obvious that those who have ordinary knowledge in the technical field to which the disclosure pertains can conceive various modifications and alterations within the scope of the technical concept described in the claims, and it is to be understood that such modifications and alterations are naturally included in the technical scope of the disclosure.

For example, although the internal combustion engine 10 described in the above embodiment includes the supercharger 30, the blow-by gas recirculation device of the disclosure can also be applied to an internal combustion engine that does not include a supercharger. In this case as well, regardless of whether supercharging of the internal combustion engine has started, fresh air can be introduced into the crank chamber, and the blow-by gas can be recirculated to the intake system. Further, when the throttle valve is fully opened, intake loss can be eliminated, and the output of the internal combustion engine can be secured.

Further, in the above-described embodiment, although the first passage is coupled to the intake manifold located on the downstream side of the throttle valve, the coupling position of the first passage is not limited as long as it is located on the downstream side of the throttle valve.

As described above, according to the disclosure, even after supercharging of the internal combustion engine has started, blow-by gas can be recirculated to the intake system while fresh air is introduced into the crank chamber.

1. A blow-by gas recirculation device comprising:
a first passage configured to provide communication between a crank chamber of an internal combustion engine and a first region of an intake system, the first region being located downstream of a throttle valve of the intake system, and configured to recirculate blow-by gas to the intake system;
a second passage configured to provide communication between the crank chamber and a second region of the intake system, the second region being located upstream of the throttle valve; and
a flow control valve unit disposed in the first passage and configured to vary a passage area according to a pressure in the first region and a pressure in the crank chamber,
wherein the flow control valve unit comprises
a first valve configured to open when the pressure in the crank chamber exceeds the pressure in the first region by a predetermined amount or more, and
a second valve configured to open when the pressure in the first region exceeds the pressure in the crank chamber by a predetermined amount or more.

2. The blow-by gas recirculation device according to claim 1,
wherein a valve body of a one of the first valve and the second valve comprises another one of the first valve and the second valve.

3. The blow-by gas recirculation device according to claim 2,
wherein the valve body of the one of the first valve and the second valve has an internal hole, and the another of the first valve and the second valve varies an opening area of the internal hole.

4. The blow-by gas recirculation device according to claim 1,
wherein the second valve is configured to close when a difference obtained by subtracting the pressure in the crank chamber from the pressure in the first region exceeds a predetermined threshold value.
